(19) United States
(12) Patent Application Publication
(10) Pub. No.: US 2002/0170394 A1
(43) Pub. Date: Nov. 21, 2002

(54) Screwdriver assembly

(76) Inventor: Chiung-Chang Tsai, Ta-Li City (TW)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 09/858,143

(22) Filed: May 15, 2001

(51) Int. Cl. B25B 23/00

(52) U.S. Cl. 81/439

(57) ABSTRACT

A screwdriver assembly includes a first screwdriver and a second screwdriver connected to each other. The two screwdrivers have different specifications to be used in different working conditions and are packaged and marketed together to reduce the packaging cost.

### BACKGROUND OF THE INVENTION

1. Field of the Invention

The present invention relates to a screwdriver assembly, and more particularly to a screwdriver assembly that includes two screwdrivers respectively having different specifications and being attached to each other.

2. Description of Related Art

With reference to FIG. 4, a conventional screwdriver in accordance with the prior art comprises a handle (50), a shank (60) detachably inserted into the handle (50) and a tip (70) inserted into the shank (60). The handle (50) has an axial bore (51) defined in one end of the handle (50). Two diametrically opposite longitudinal keyways (52) are respectively defined in the bore (51). An axial through hole is defined through the shank (60). Two opposite ends of the through hole are polygonal. Two diametrically opposite ribs (not shown) extend outward from the periphery near the middle portion of the hollow shank (60) to engage to the corresponding keyways (52) when the hollow shank (60) is inserted into the handle (50). The tip (70) has at least one working end and a middle portion to insert into and engage the end of the shank (60). However, the shank (60) of the conventional screwdriver has a fixed length. The user must use a screwdriver with a short handle and shank when the working area is small. It is inconvenient and the short screwdriver is easily lost.

The present invention has arisen to mitigate and/or obviate the disadvantages of the conventional screwdriver.

### SUMMARY OF THE INVENTION

The main objective of the present invention is to provide an improved screwdriver assembly. The screwdriver assembly of the present invention includes a first screwdriver and a second screwdriver connected to each other. The two screwdrivers have different specifications to be used in different working conditions.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a screwdriver assembly in accordance with the present invention;

FIG. 2 is an exploded perspective view of the screwdriver assembly in FIG. 1;

FIG. 3 is a side plan view in partial section of the screwdriver assembly in FIG. 1; and

FIG. 4 is a perspective view of a conventional screwdriver in accordance with the prior art.

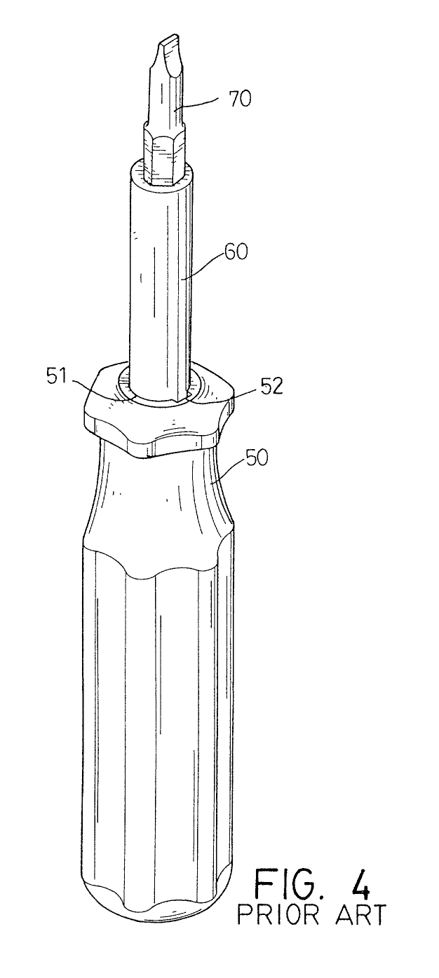

### DETAILED DESCRIPTION OF THE INVENTION

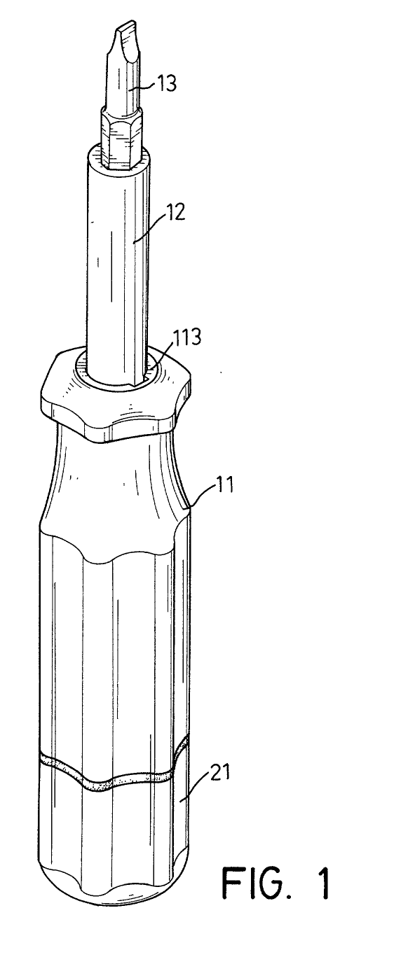

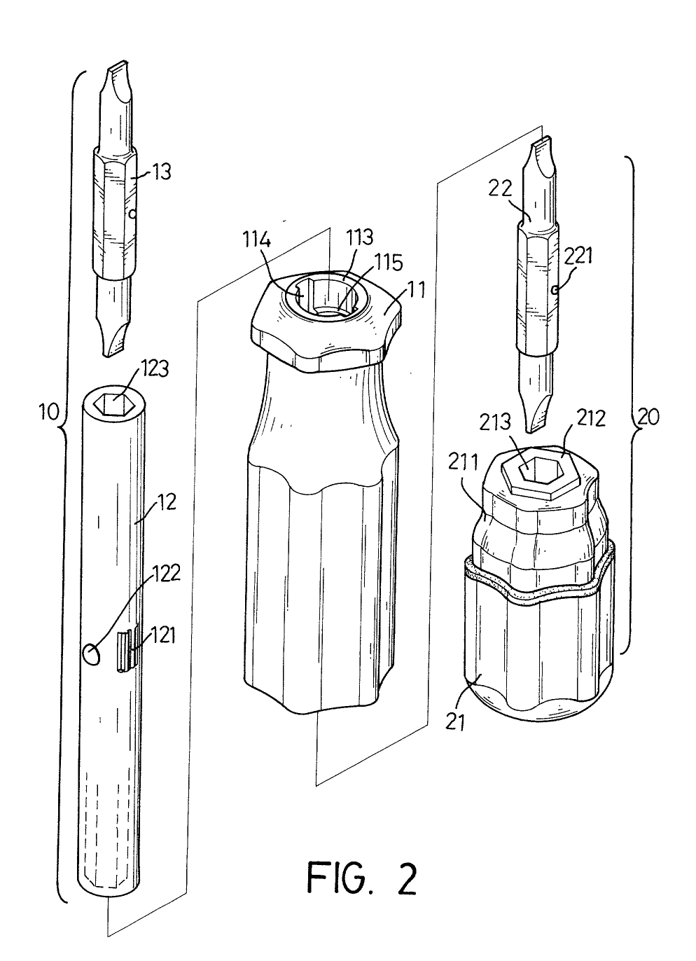

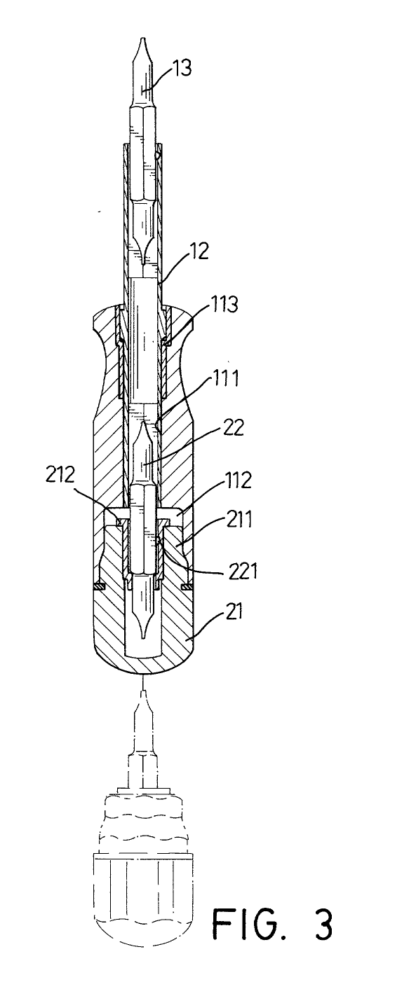

Referring to the drawings and initially to FIGS. 1-3, a screwdriver assembly in accordance with the present invention comprises first screwdriver (10) and a second screwdriver (20). The first screwdriver (10) is longer than the second screwdriver (20).

The first screwdriver (10) includes a long handle (11), a shank (12) detachably inserted into the long handle (11) and a first tip (13) changeably inserted into the shank (12). The long handle (11) includes an axial through hole (111) defined through the long handle (11). The long handle (11) includes a first end having a first tube (113) secured in the long handle (11) and a second end having a cavity (112) defined to receive part of the second screwdriver (20). The first tube (113) has two ends with different diameters where one end is an inner end and the other is an outer end. The inner diameter of the inner end is equal to that of the through hole (111) in the long handle (11), and the cavity (112) in the second end of the long handle (11) communicates with the through hole (111) in the long handle (11). The outer end of the first tube (113) is flush with the end of the long handle (11). The first tube (113) has at least one longitudinal keyway (114) defined in an inner periphery of the first tube (113) and an annular detent (115) defined on the inner periphery of the first tube (113). In the preferred embodiment, the first tube (113) has two diametrically opposite longitudinal keyways (114) defined in the first tube (113).

The shank (12) is hollow and the inner peripheries (123) of two opposite ends of the shank (12) are polygonal. Each end of the shank (12) has an annular detent (not shown) defined near the ends. The shank (12) includes at least one longitudinal rib (121) extending from the periphery of the shank (12) and corresponding to the keyway (114) in the first tube (113). A steel ball (122) is retractably mounted in the periphery of the shank (12) and corresponds to the annular detent (115) in the first tube (114). The rib (121) on the shank (12) engages the keyway (114) in the first tube (113), and the top of the steel ball (122) in the shank (12) snaps into the annular detent (115) in the first tube (113) to hold the hollow shank (12) in place when the hollow shank (12) is inserted into the long handle (11).

The second screwdriver (20) includes a short handle (21) having a stub (211) axially extending from one end of the short handle (21) toward the long handle (11). The shape of the stub (211) corresponds to and is slightly larger than that of the cavity (112) in the second end of the long handle (11) so that the second screwdriver (20) can be held in the second end of the first screwdriver (10) when the stub (211) is inserted into the cavity (112) of the long handle (11). A second tube (212) with a polygonal through hole (213) is axially inserted into the stub (211) of the short handle (21). A second tip (22) is inserted into and engages the through hole (213) in the second tube (212). A polygonal surface is formed on a middle portion of the second tip (22) so that the second tip (22) can be engaged in the through hole (213) of the second tube (212). A steel ball (221) is retractably mounted in one side of the middle portion of the second tip (22). The steel ball (221) abuts the inner periphery of the through hole (213) of the second tube (212) to hold the second tip (22) in the second tube (212) when the second tip (22) is inserted into the through hole (213) in the second tube (212).

The screwdriver assembly in accordance with the present invention has the following advantages.

1. It is convenient to use. The screwdriver assembly has two screwdrivers with different specifications and can be carried together to suit different working conditions so that it is a convenient design for the user to use the screwdriver.

2. Two screwdrivers with different specifications are packaged and marketed together to reduce the packaging cost.

Although the invention has been explained in relation to its preferred embodiment, it is to be understood that many other possible modifications and variations can be made without departing from the spirit and scope of the invention as hereinafter claimed.

What is claimed is:

1. A screwdriver assembly comprising:
a first screwdriver including a long handle (11), a shank (12) inserted into the long handle (11), and a first tip (13) detachably inserted into and engaged with the shank (12); the long handle (11) having an axial through hole (111) defined through the long handle, the long handle including a first end having a first tube (113) securely received in the long handle (11) and a second end having a cavity defined in the long handle (11) and communicating with the through hole (111) in the long handle (11); the shank (12) extending through the first tube (13) to engage the first tube and partially received in the through hole (111) in the long handle (11), the shank (12) having two opposite ends respectively being polygonal for receiving and engaging the first tip (13); and
a second screwdriver having a short handle connected to the second end of the long handle (11), the short handle (21) having an axial stub (211) extending from one end of the short handle (21) and detachably secured in the cavity (112) in the second end of the long handle (11), a second tube (212) centrally secured in the stud (211) for receiving and engaged a second tip (22) in the short handle (21).

2. The screwdriver assembly as claimed in claim 1, wherein the first tube (113) in the long handle (11) comprises at least one longitudinal keyway (114) defined in an inner periphery of the first tube (113) and the shank (12) comprises at least one longitudinal rib (121) extending out from a periphery of the shank (12) to engage the longitudinal keyway (114) in the first tube (113) when the shank (12) is inserted into the long handle (11).
